(19) United States
(12) Patent Application Publication
(10) Pub. No.: US 2014/0151360 A1
(43) Pub. Date: Jun. 5, 2014

(54) HEATER ASSEMBLY FOR DISK PROCESSING SYSTEM

(71) Applicant: WD MEDIA, INC., (US)

(72) Inventors: LANDDELL GREGORY, GEORGETOWN (MY); ZATUL 'ITRI B. ZAINUDDIN, KANGAR (MY); CHI CHOY LIM, SUNGAI ARA (MY)

(73) Assignee: WD MEDIA, INC., San Jose, CA (US)

(21) Appl. No.: 13/691,736

(22) Filed: Nov. 30, 2012

(51) Int. Cl. H05B 3/10

(52) U.S. Cl. CPC H05B 3/10
USPC 219/444.1; 219/531

(57) ABSTRACT

A heater assembly for a disk processing system including a heater element configured to heat a substrate carried by a holder, and a heater cover having an aperture to expose the heater element to the substrate. The cover may be metal to thermally couple the heater to a cooling plate. The cover may have an outer surface having a thermal barrier surrounding the aperture to thermally insulate the holder.

### FIELD

The present disclosure relates generally to heater assemblies for disk processing systems, and more particularly to a heater assembly configured to heat a substrate carried by a holder while reducing heat on the holder.

### BACKGROUND

Disk processing systems are commonly used to manufacture magnetic disks for hard disk drives. These systems generally include several process stations that work together to deposit thin layers of material onto substrates. A disk transport system may be used to transport the substrates on holders through the process stations

The number of process stations and the type of processes performed on the substrates may vary depending on the particular application and the over design requirements. Generally, the disk processing system may employ a combination of sputtering and chemical vapor deposition processes. The disk processing system may also have additional stations to support the deposition process including, by way of example, heating stations to heat the substrates.

Sputtering is a process whereby material is removed from a target and deposited onto the surface of the substrate. Unfortunately, the material is also deposited on the holder transporting the substrate through the disk processing system. When a sputter coated holder is heated downstream in a heating station, the holder expands causing sputter particles to dislodge. These particles can come into contact with and adhere to the substrate, resulting in defects in the finished article.

Accordingly, there is a need to reduce the heat applied to the holder to minimize particulates which might lead to defective articles.

### SUMMARY

Several aspects of the present invention will be described more fully hereinafter with reference to various embodiments of apparatuses and methods related to heating assemblies for disk processing systems and other machines.

One aspect of a heater assembly for a disk processing system described in this disclosure includes a heater element configured to heat a substrate carried by a holder, and a heater cover having an aperture to expose the heater element to the substrate, wherein the cover further comprises an outer surface having a thermal barrier surrounding the aperture to thermally insulate the holder.

Another aspect of a heater assembly for a disk processing system described in this disclosure includes a heater element configured to heat a substrate carried by a holder, a cooling plate, and a heater cover having an aperture to expose the heater element to the substrate, wherein the cover comprises a metal to thermally couple the heater element to the cooling plate.

One aspect of a method for heating a substrate carried by a holder in a disk processing system described in this disclosure includes heating the substrate with a heater element that radiates through an aperture in a heater cover, and thermally insulating the holder while heating the substrate via a thermal barrier on an outer surface of the cover surrounding the aperture.

Another aspect of a method for heating a substrate carried by a holder in a disk processing system described in this disclosure includes heating the substrate with a heater element that radiates through an aperture in a metal heater cover, and thermally coupling the heater element to a cooling plate via a metal heater cover.

It will be understood that other aspects of the present invention will become readily apparent to those skilled in the art from the following disclosure, wherein it is shown and described only several embodiments of the invention by way of illustration. As will be realized by those skilled in the art, the present invention is capable of other and different embodiments and its several details are capable of modification in various other respects, all without departing from the spirit and scope of the invention. Accordingly, the drawings and detailed description are to be regarded as illustrative in nature and not as restrictive.

### BRIEF DESCRIPTION OF THE DRAWINGS

Various aspects of the present invention will now be presented in the detailed description by way of example, and not by way of limitation, with reference to the accompanying drawings, wherein:

FIG. 1 is a schematic representation illustrating an exemplary embodiment of a disk processing system.

FIG. 2A is a perspective view illustrating an exemplary embodiment of a heater station for a disk processing system.

FIG. 2B is a cut away, perspective view of the heater station illustrated in FIG. 2A.

FIG. 3A is a perspective view illustrating an exemplary embodiment of the heater assembly for a heater station in a disk processing system.

FIG. 3B is a cross-sectional view of the heater assembly illustrated in FIG. 3A.

FIG. 3C is a perspective view of an exemplary embodiment of a heater for the heater assembly illustrated in FIG. 3A.

FIG. 4 is a perspective exploded view of an exemplary embodiment of a heater for a heater assembly.

### DETAILED DESCRIPTION

The detailed description is intended to provide a description of various exemplary embodiments of the present invention and is not intended to represent the only embodiments in which the invention may be practiced. The term “exemplary” used throughout this disclosure means “serving as an example, instance, or illustration,” and should not necessarily be construed as preferred or advantageous over other embodiments. The detailed description includes specific details for the purpose of providing a thorough and complete disclosure that fully conveys the scope of the invention to those skilled in the art. However, the invention may be practiced without these specific details. In some instances, well-known processes, structures or components may be shown in block diagram form, or omitted entirely, in order to avoid obscuring the various concepts presented throughout this disclosure.

In the following detailed description, various aspects of the present invention will be presented in the context of a heater assembly for a disk processing system. While these inventive aspects may be well suited for this application, those skilled in the art will realize that these aspects may be extended to other processing systems to produce different articles. By way of example, various aspects of the present invention may be used in processing systems to manufacture semiconductors or any other suitable articles that require heating during fabrication. Accordingly, any reference to a heating assembly in a disk processing system is intended only to illustrate the various aspects of the present invention, with the understanding that such aspects may have a wide range of applications.

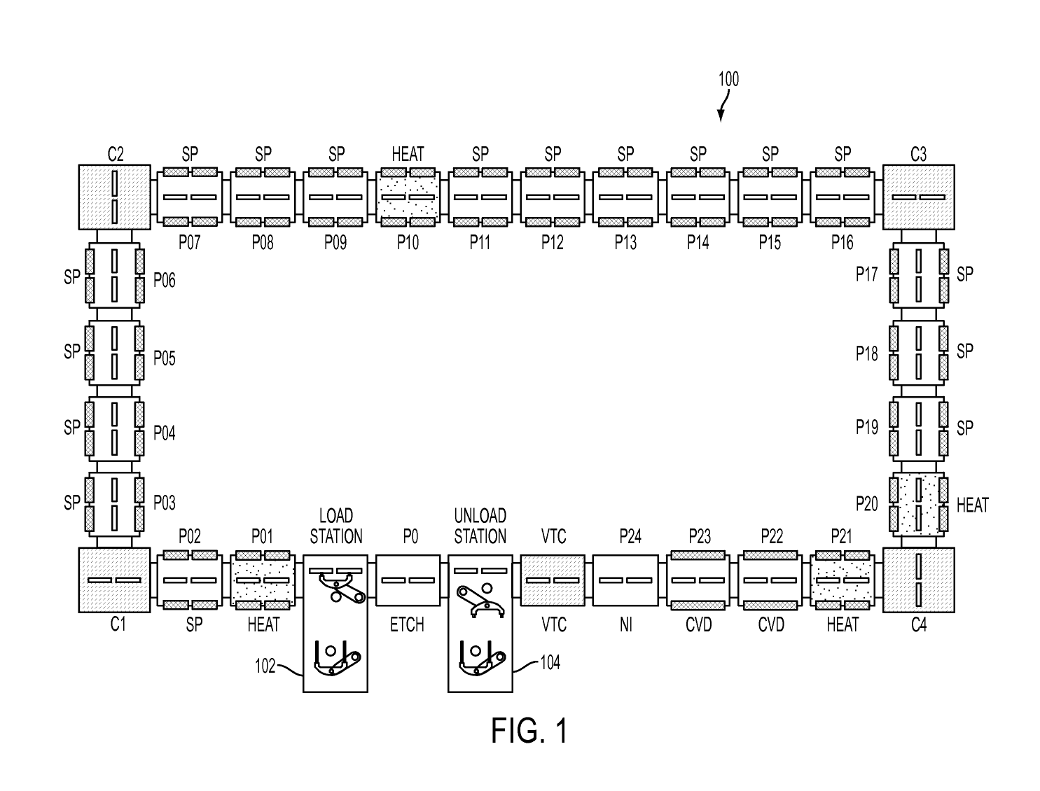

FIG. 1 is a schematic representation illustrating an exemplary embodiment of a disk processing system. The disk processing system 100 is shown with a number of process stations having four linear sections connected together by four corner process stations. Alternatively, the disk processing system may have one continuous linear section, or may be arranged in any other suitable fashion. The number of process stations and the type of processes performed on the substrates may vary depending on the particular application and the overall design constraints of the articles being manufactured. A disk transport system may be used to transport substrates on holders through the process stations. Examples of disk processing systems include the Anelva 3040 and 3050 manufactured by Canon Anelva Corporation, but the various aspects of the invention presented throughout this disclosure may be applied to any suitable disk processing systems or other machine.

The process stations work together to deposit thin layers of material onto substrates. As discussed earlier in the background portion of this disclosure, the disk processing system may employ a combination of sputtering and chemical vapor deposition processes. The disk processing system may also have additional stations to support the deposition process including, by way of example, a loading station for introducing the substrates into the system, heating stations to heat the substrates, and an unloading station to remove the substrates from the system.

In the exemplary embodiment shown in FIG. 1, the substrates are loaded into holders at the loading station 102 for transport through the disk processing system. The substrates are then heated at heating station P1 and then several layers of thin material are deposited onto the substrates at sputtering stations P2-P9. This process is repeated with the substrates being heated at heating station P10 and then several more layers of thin material being deposited onto the substrates at sputtering stations P11-P19. The substrates are then heated again at heating stations P20 and P21 before several more layers of thin material are deposited onto the substrates using a chemical vapor deposition process at process stations P22-P23. At station P24 nitrogen may be implanted into the surface of the substrates to provide better bonding of lubricant during post processing. The substrates are then passed through a vacuum tunnel chamber (VTC) to an unloading station 104 where the substrates are removed from the holders and output from the disk processing system. The holders are then moved to an etching station P0 to remove residual deposition material before being provided back to the loading station 102 to transport new substrates through the disk processing system 100.

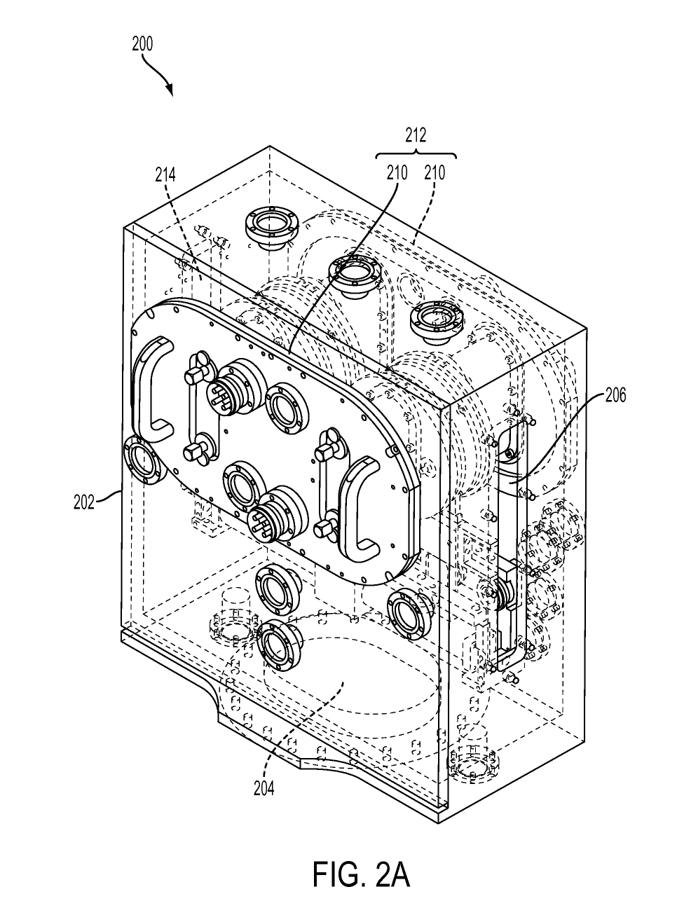

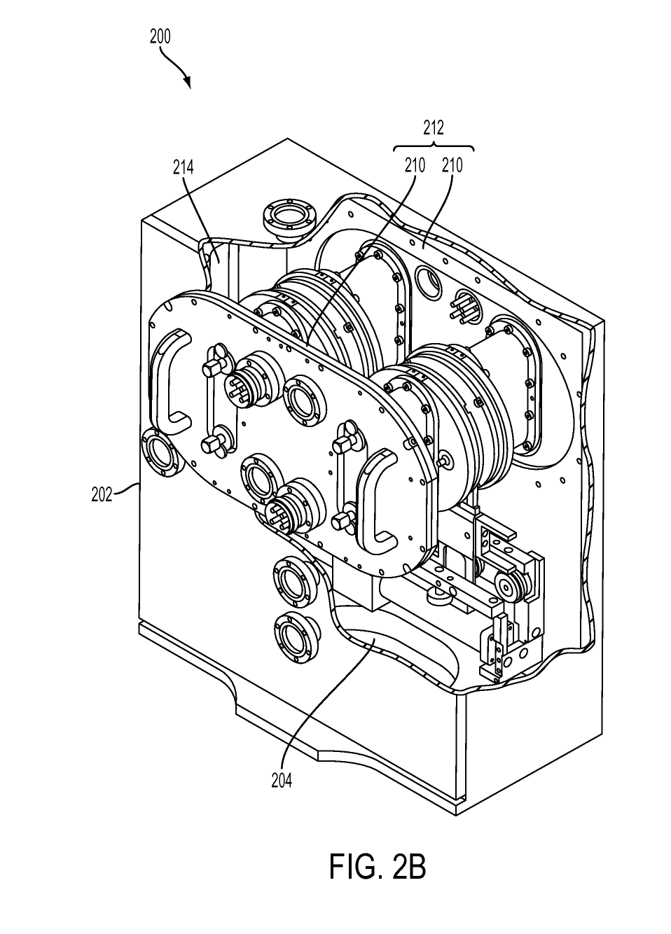

An exemplary embodiment of a heater station in a disk processing system will now be presented with reference to FIGS. 2A and 2B. The heater station 200 includes a vacuum sealed chamber 202 with its own pumping system. The pumping system includes a pump (not shown) connected to an evacuation port 204 located on the bottom wall of the chamber 202. The pump is used to evacuate the chamber 202 and maintain a partial vacuum during the heating process.

The disk transport system moves the substrates on holders into the heating station 200 through an entry slot 206 in the side wall of the chamber 202. The substrates are then positioned between two heaters 210 which together form the heater assembly 212. The substrates are heated by the two heaters 210 to the appropriate temperature for downstream processing. Once the substrates are heated, the disk transport system moves the substrates through an exit slot 214 in the opposite side wall of the chamber 202.

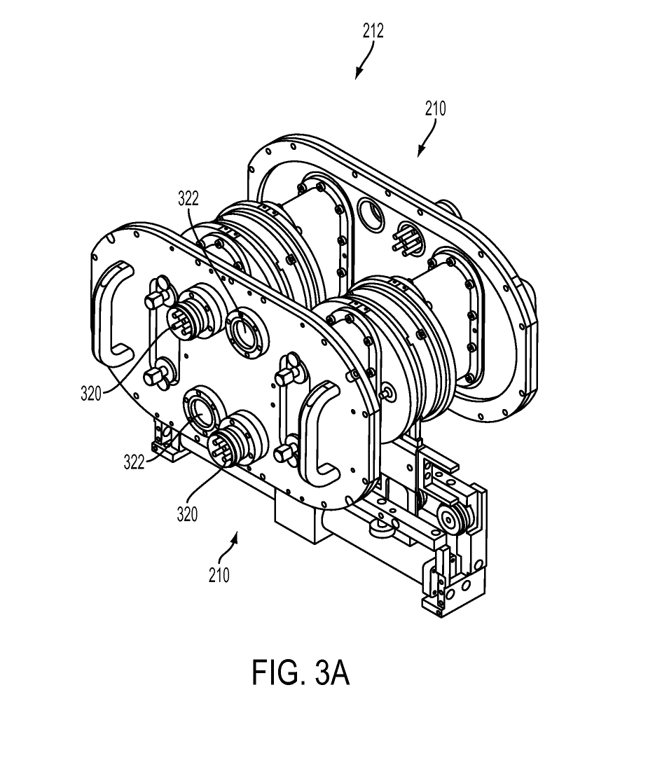

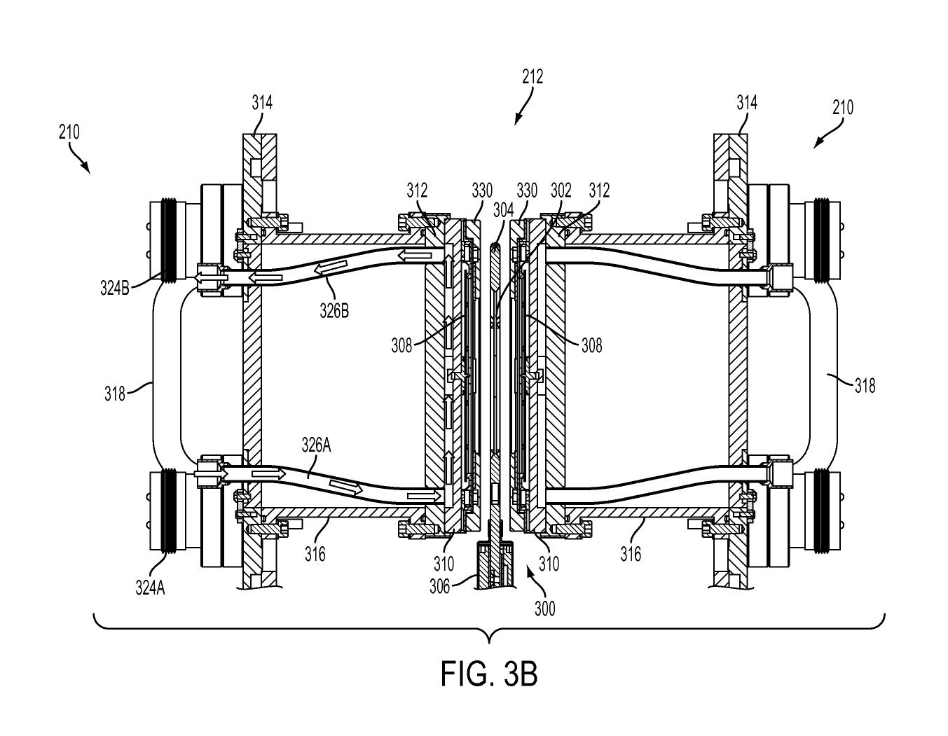

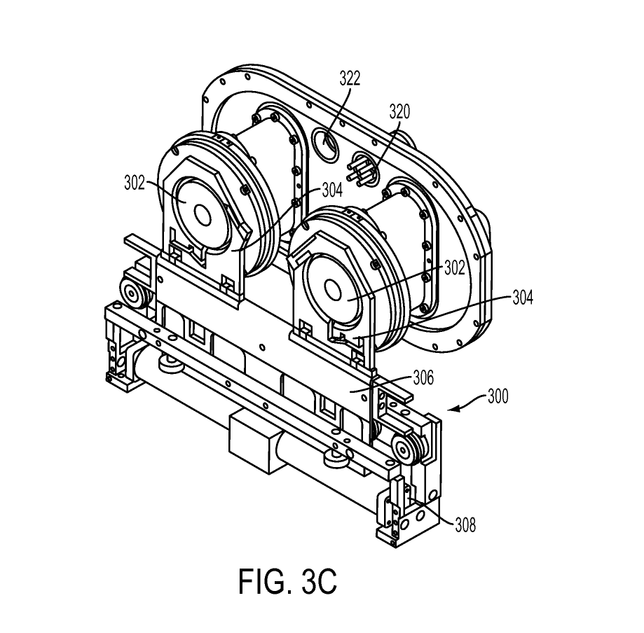

The disk transport system is best seen in FIG. 3C. FIG. 3C is a perspective view showing the disk transport system 300 positioned in front of one heater with the other heater omitted. The disk transport system 300 is shown with two holders 304 each carrying a substrate 302. Each holder is designed to carry a single-sided or double-sided substrate. In an alternative embodiment, each holder 304 may be used to carry two single-sided substrates that are secured back-to-back with each side to be processed facing outwards. Although the disk transport system 300 is shown with two holders 304, those skilled in the art will readily appreciate that the disk transport system 300 may have only a single holder, or alternatively, any number of holders to carry any number of substrates. In the exemplary disk transport system presented in FIG. 3C, the two holders 304 are coupled to an extension plate 306 riding on a motorized rail system 308. The height of the extension plate 306 is designed to position the substrates 302 between the two heaters 210 during the heating process (see FIG. 2).

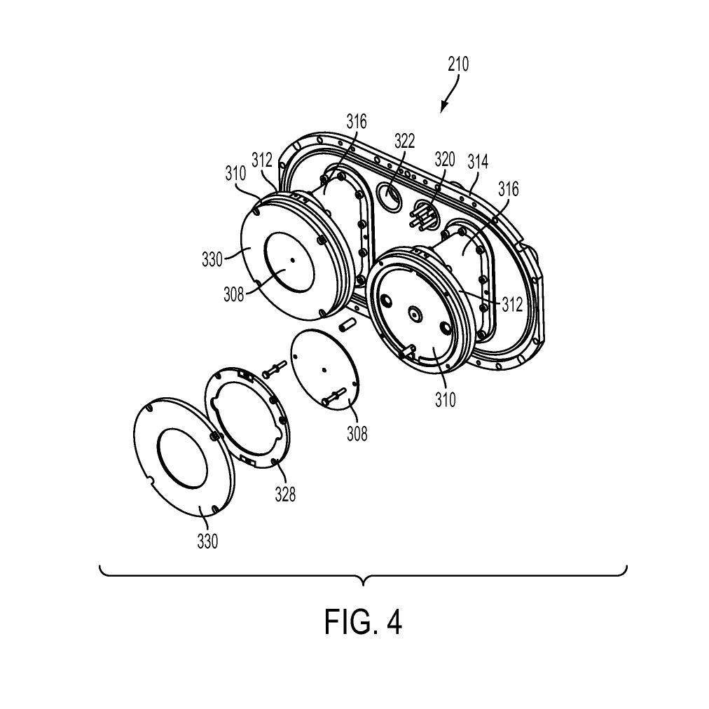

FIG. 3A is a perspective view and FIG. 3B is a cross-sectional view of an exemplary embodiment of the heater assembly. The heater assembly 212 includes two heaters 210. FIG. 4 is an exploded view of one heater. In the exemplary embodiment described thus far, the two heaters 210 have the same structure, and therefore, only a single heater will be described for brevity. As those skilled in the art will readily appreciate, that description applies equally to both heaters.

The heater 210 is shown with two heater elements 308, but may have any number of heater elements depending on the particular application and the overall design constraints. In this example, each heater element 308 is designed as circular disk that emits heat when an electrical current is applied, however, the heater elements 308 may be any suitable device capable of converting electrical energy into heat. Each heater element 308 fits into a recess formed in a corresponding cooling plate 310. Each cooling plate 310 is secured to a corresponding mounting plate 312 positioned at the distal end of a corresponding spacer 316 attached to a rear panel 314. The rear panel 314 provides a means for mounting the heater 210 to the chamber wall of the heating station (see FIGS. 2A and 2B). The rear panel 314 may include a handle 318 to facilitate the installation and removal of the heater 210.

The rear panel 314 provides an interface between the external environment and the interior of the chamber. In this example, the rear panel 314 includes two electrical connectors 320 and two thermocouples 322. The electrical connectors 320 provide a means to connect an external power source (not shown) to the heater elements 308. The external power source may be configured to apply power to the heater elements 308 when the substrates 302 are positioned between the two heaters 210 by the disk transport system 300. Alternatively, power may be applied to the heating elements 210 before the substrates are moved into position to preheat the heating elements 210. The thermocouples 322 may be used to monitor the temperature of the heater elements 308, and in some cases, control the application of power to the heating elements 210 to ensure the proper temperature during the heating process.

The rear panel 314 also includes two coolant ports 324, which together with the cooling plate 310 and the passageways 326 extending through the spacer 316 from the cooling plate assembly. In a manner to be described in greater detail below, the cooling plate assembly may be used to reduce the heat applied to the holder 304 during the heating process. In this example, a coolant source (not shown), such as a water pump or the like, may be used to circulate coolant through the cooling plate assembly. More specifically, the coolant source pumps coolant through the inlet port 324A and inlet passageway 326A into a chamber defined by the cooling plate 310 and the mounting plate 312. The coolant flows through the chamber and out though the outlet passageway 326B and outlet port 324B back to the coolant source.

As described above, each heater element 308 is mounted into a recess formed in a corresponding cooling plate 310. The recess is thermally insulated to prevent cooling of the heater element 308 by the cooling plate assembly. Each heater element 308 is mounted to its corresponding cooling plate 310 with a center flange 328 or by some other suitable means. A heater cover 330 is positioned over each heater element 308. The heater cover 330 is formed with an aperture that exposes the heater element to the substrate 302. In this example, the aperture is designed to have substantially the same and size as the substrate 302 so that during the heating process, the heater element 308 is aligned with the substrate 302 and the heater cover 330 is aligned with the holder 304. The heater cover 330 is also thermally coupled to the cooling plate. As result, heat created by the heating element 308 that would otherwise be transferred from the heater cover 330 to the holder 304 is thermally coupled to the cooling plate 310 and dissipated by the coolant circulating through the spacer 316. The heater cover 330 may be formed from a metal material, such as, by way of example, copper. Alternatively, the heater cover 330 may formed from gold, silver, titanium, molybdenum, grapheme, or any other suitable material having a high thermal conductance. In one embodiment, the heater cover 330 may be formed from an oxygen free material, such as oxygen free copper. Oxygen free materials do not outgas and release impurities in a vacuum. The heater cover 330 may be coated with a thermal barrier on the surface facing the holder 304 to thermally insulate the holder 304. By way of example, the heater cover 330 may have a zirconia oxide coating or some other suitable coating.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other machines. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A heater assembly for a disk processing system, comprising:
a heater element configured to heat a substrate carried by a holder; and
a heater cover having an aperture to expose the heater element to the substrate, wherein the heater cover further comprises an outer surface having a thermal barrier surrounding the aperture to thermally insulate the holder.

2. The heater assembly of claim 1 wherein the thermal barrier comprises zirconia oxide.

3. The heater assembly of claim 1 further comprising a cooling plate, wherein the heater cover thermally couples the heater element to the cooling plate.

4. The heater assembly of claim 3 wherein the heater cover comprises a metal that provides the thermal coupling between the heater element and the cooling plate.

5. The heater assembly of claim 4 wherein the metal comprises copper.

6. The heater assembly of claim 5 wherein the copper comprises oxygen free copper.

7. A heater assembly for a disk processing system, comprising:
a heater element configured to heat a substrate carried by a holder;
a cooling plate; and
a heater cover having an aperture to expose the heater element to the substrate, wherein the heater cover comprises a metal to thermally couple the heater element to the cooling plate.

8. The heater assembly of claim 7 wherein the metal comprises copper.

9. The heater assembly of claim 8 wherein the copper comprises oxygen free copper.

10. The heater assembly of claim 7 wherein the heater cover comprises an outer surface having a zirconia oxide thermal barrier surrounding the aperture to thermally insulate the holder.

11. A method of heating a substrate carried by a holder in a disk processing system, comprising:
heating the substrate with a heater element that radiates through an aperture in a heater cover; and
thermally insulating the holder while heating the substrate via a thermal barrier on an outer surface of the heater cover surrounding the aperture.

12. The method of claim 11 wherein the thermal barrier comprises zirconia oxide.

13. The method of claim 11 further comprising thermally coupling the heater element to a cooling plate via the heater cover.

14. The method of claim 13 wherein the heater cover comprises a metal that thermally couples the heater element to the cooling plate.

15. The method of claim 14 wherein the metal comprises copper.

16. The method of claim 15 wherein the copper comprises oxygen free copper.

17. A method of heating a substrate carried by a holder in a disk processing system, comprising:
heating the substrate with a heater element that radiates through an aperture in a metal heater cover; and
thermally coupling the heater element to a cooling plate via a metal heater cover.

18. The method of claim 17 wherein the metal comprises copper.

19. The method of claim 18 wherein the copper comprises oxygen free copper.

20. The method of claim 17 further comprising thermally insulating the holder while heating the substrate via a zirconia oxide thermal barrier on an outer surface of the heater cover surrounding the aperture.
